(19) United States
(12) Patent Application Publication
(10) Pub. No.: US 2026/0099422 A1
(43) Pub. Date: Apr. 9, 2026

(54) Delta Code Identification and Validation Using Artificial Intelligence

(71) Applicant: Bank of America Corporation, Charlotte, NC (US)

(72) Inventors: Sivasankar Karunagaran, Harrison, NJ (US); Ramya Senthil Kumar, Erode (IN); Aparna Ganesan, Chennai (IN)

(21) Appl. No.: 18/909,239

(22) Filed: Oct. 8, 2024

(51) Int. Cl. G06F 11/36

(52) U.S. Cl. CPC G06F 11/3608; G06F 11/368

(57) ABSTRACT

Aspects of the disclosure related to delta code identification and validation. A computing platform may use an AI engine to convert historical information into a machine readable format. The computing platform may configure a Q learning module. The computing platform may receive delta code and input the delta code into the Q learning module. The computing platform may output, using the Q learning module, one or more scenarios. The computing platform may output, using an association mapping module, one or more unit test cases. The computing platform may validate the delta code using the one or more unit test cases. The computing platform may send the validated delta code and commands directing an enterprise system to deploy the validated delta code.

### BACKGROUND

Aspects of the disclosure relate to software code changes and/or updates in an enterprise system. In some instances, applications within an enterprise system may need to be modified and/or updated to accommodate new versions of code that may be deployed on the enterprise system. This may lead to extensive testing and/or validating of the code, which may be time intensive and/or consume excess computing resources. Accordingly, it may be advantageous to improve the process of testing and/or validating code changes.

### SUMMARY

Aspects of the disclosure provide effective, scalable, and convenient technical solutions that address and overcome the technical problems associated with the identification and validation of code changes in one or more applications within an enterprise system. In accordance with one or more embodiments of the disclosure, a computing platform comprising at least one processor, a communication interface, and memory storing computer-readable instructions may use an artificial intelligence (AI) engine to convert historical information into machine readable information, where the historical information may include one or more peer review comments and one or more historical defects. The computing platform may configure a Q learning module using the machine readable information and a database of scenarios, and the configuring may prepare the Q learning module to receive delta code and to identify one or more scenarios from the database of scenarios associated with the delta code. The computing platform may receive first delta code from an enterprise user device. The computing platform may input the first delta code into the Q learning module. The computing platform may output, using the Q learning module, based on the first delta code, and based on the machine readable information and the database of scenarios, one or more scenarios associated with the first delta code. The computing platform may output, based on the one or more scenarios and using an association mapping module, one or more unit test cases based on the one or more scenarios, where the one or more unit test cases are used to validate the first delta code. The computing platform may validate the first delta code using the one or more unit test cases. The computing platform may send, to the enterprise system, the validated first delta code and commands directing the enterprise system to deploy the validated first delta code, which may cause the enterprise system to deploy the validated first delta code.

In some instances, the computing platform may generate a report, which may include the one or more identified scenarios and the one or more unit test cases that were used to validate the code. In some examples, the computing platform may send, to the enterprise user device, the report and one or more commands directing the enterprise user device to display the report, which may cause the enterprise user device to display the report. In some instances, the one or more unit test cases that are output by the association rule mapping module may include overlapping unit test cases across the one or more identified scenarios.

In one or more examples the computing platform may receive one or more issues associated with the validated delta code that was deployed at the enterprise system. The computing platform may identify one or more additional unit test cases to revalidate the validated first delta code using the association rule mapping module and based on the one or more issues. The computing platform may revalidate the validated first delta code using the one or more additional unit test cases. The computing platform may send, to the enterprise system, the revalidated first delta code and new commands directing the enterprise system to redeploy the revalidated first delta code, which may cause the enterprise system to redeploy the revalidated delta code.

In some instances, the AI engine may include a natural language processing (NLP) algorithm or a large language model (LLM). In one or more examples, the computing platform may train the AI engine, where the training may include, preprocessing the historical information, vectorizing the historical information, storing the vectorized information into a vector database, performing a dynamic query of the vectorized information, and outputting the vectorized information to the Q learning module.

In some instances, the database of scenarios may include one or more common patterns or one or more missed scenarios. In one or more examples, the computing platform may update, using a dynamic feedback loop and based on the receiving, the identifying, and the revalidating, the Q learning module. In some instances, the computing platform may send, to the enterprise user device, an updated report that may indicate that the validated delta code was revalidated by the one or more additional unit test cases.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for delta code identification and validation in accordance with one or more aspects described herein;

FIGS. 2A-2F depict an illustrative event for delta code identification and validation in accordance with one or more aspects described herein;

FIGS. 3-5 depict illustrative methods for delta code identification and validation in accordance with one or more aspects described herein;

FIG. 6 depicts an illustrative diagram for delta code identification and validation in accordance with one or more aspects described herein; and

FIG. 7 depicts an illustrative graphical user interface for delta code identification and validation in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to the identification and validation of delta code for an enterprise system. In banking applications (e.g., mobile applications), frequent monthly releases may be imminent as an institution may receive periodic customer feedback and there may also be a constant demand to provide customers with new feature updates. This may mean an application codebase may need to undergo numerous changes for each version of release. Each time there is an update, whether the update may be an existing functional code change or an introduction of new functional code blocks, it may be crucial to test those changes effectively by identifying scenarios and test cases to validate the changes. If the test cases might not be updated for existing code blocks or if new ones might not be created for new blocks, the update may result in missed scenarios. This oversight may cause significant bottlenecks, higher risk of discovering bugs late in the cycle, and/or other problems particularly during post production.

Banking applications such as mobile applications which may be highly deployable may rely heavily on the trust of their users. Any undetected bugs or failures may directly affect the user experience, and may require excess computing resources to fix and/or resolve. Also, failing to address this issue may lead to operational inefficiencies, increased maintenance costs, and/or a prolonged development cycle. The inability to quickly identify and resolve issues may hinder the overall agility and responsiveness of the development team.

Accordingly, described herein is a system that may be built to monitor new code changes, which may review, identify, build, and/or update the unit level scenarios that may need to be auto-validated through a comprehensive approach involving artificial intelligence (AI) and/or machine learning (ML).

Accordingly, the solution may be achieved through a utility, which may create an automated feedback artifactory that may leverage natural language processing (NLP) algorithms. Learning from the past issues and testing insights may be continuously updated with each release, which may create a repository of testing insights and defect patterns through, for example, Q-learning. Finally, using association rules mapping the system may map the unit test scripts list with generated scenarios that may be required to run for each change, and further the system may auto-validate the changes by executing these generated scenarios.

These and other features are described in further detail below.

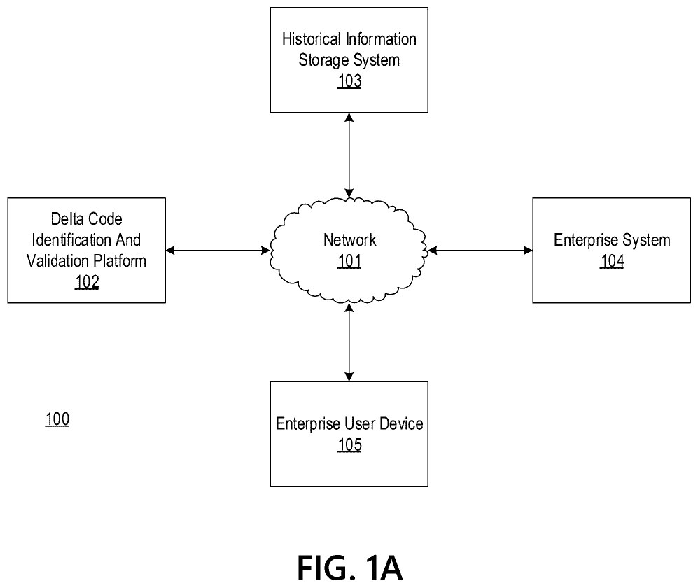

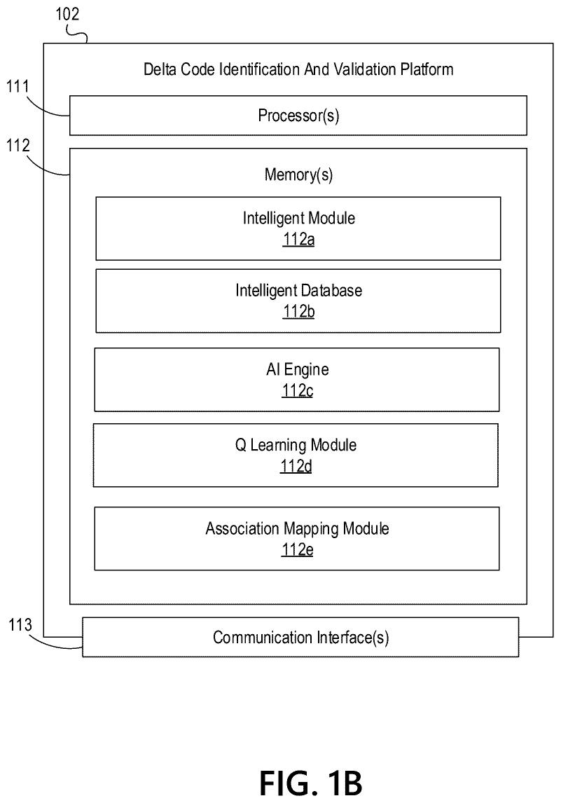

FIGS. 1A-1B depict an illustrative computing environment for delta code identification and validation in accordance with one or more aspects described herein. Referring to FIG. 1A, computing environment 100 may include one or more computer systems. For example, computing environment 100 may include delta code identification and validation platform 102, historical information storage system 103, enterprise system 104, and enterprise user device 105.

As described further below, delta code identification and validation platform 102 may be a computer system that includes one or more computing devices (e.g., servers, server blades, or the like) and/or other computer components (e.g., processors, memories, communication interfaces) that may be used to train, host, configure and/or otherwise refine an artificial intelligence (AI) engine, a Q learning module, and/or an association mapping module, which may be used to identify one or more scenarios based on delta code received from, enterprise user device 105, identify one or more unit test cases to validate the delta code based on the identified scenarios, and/or perform other functions.

Historical information storage system 103 may be or include one or more computing devices (e.g., servers, server blades, or the like) and/or computer components (e.g., processors, memories, communication interfaces, and/or other components). In some instances, historical information storage system 103 may store information that may be used to train an AI engine, and/or perform other functions. In some instances, historical information storage system 103 may be configured as a cloud storage system, in which historical information storage system 103 may support and/or host a cloud computing model that stores information on the Internet through a cloud computing provider who manages and/or operates historical information storage system 103 as a service. In some instances, historical information storage system 103 may be local or non-cloud based storage, such as a backend server or database associated with an enterprise organization (e.g., a financial institution).

Enterprise system 104 may be a computer system that includes one or more computing devices (e.g., servers, server blades, a laptop computer, desktop computer, smartphone, smartwatch, tablet, and/or other device) and/or other computer components (e.g., processors, memories, communication interfaces). The enterprise system 104 may further collect, store, host, and otherwise run functions such as applications that enterprise system 104 may utilize in order to provide for a cross-functional system that provides organization-wide coordination and integration of key business processes that helps in planning the resources of an organization. In some instances, enterprise system 104 may receive validated code from delta code identification and validation platform 102 and instructions/commands to build and/or deploy the validated code at enterprise system 104 (e.g., within an application of enterprise system 104).

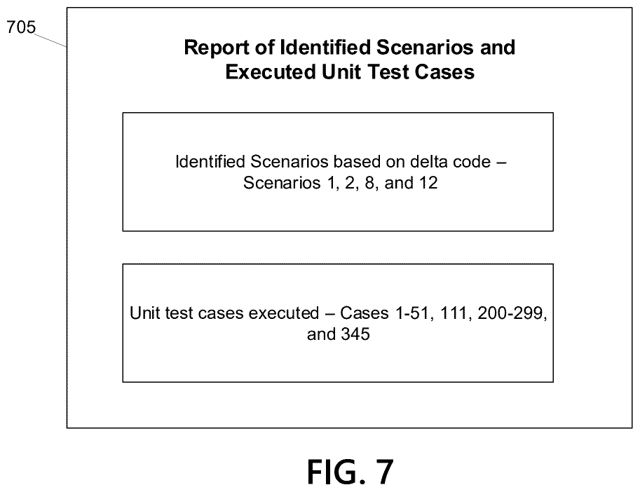

Enterprise user device 105 may be and/or otherwise include a laptop computer, desktop computer, mobile device, tablet, smartphone, server, server blade, and/or other device that may be configured to receive and/or display a report (e.g., including information about identified scenarios based on delta code, unit test cases executed to validate the delta code based on the identified scenarios, and/or other information) using one or more user interfaces (e.g., FIG. 7), on behalf of an enterprise organization, such as a financial institution. In some instances, enterprise user device 105 may be used by a developer associated with enterprise system 104, and may create delta code for an update within enterprise system 104, send the delta code to delta code identification and validation platform 102, and/or perform other functions.

Computing environment 100 also may include one or more networks, which may interconnect delta code identification and validation platform 102, historical information storage system 103, enterprise system 104, and/or enterprise user device 105. For example, computing environment 100 may include a network 101 (which may interconnect, e.g., delta code identification and validation platform 102, historical information storage system 103, enterprise system 104, and/or enterprise user device 105).

In one or more arrangements, delta code identification and validation platform 102, historical information storage system 103, enterprise system 104, and/or enterprise user device 105 may be any type of computing device capable of sending and/or receiving requests and processing the requests accordingly. For example, delta code identification and validation platform 102, historical information storage system 103, enterprise system 104, and/or enterprise user device 105, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all delta code identification and validation platform 102, historical information storage system 103, enterprise system 104, and/or enterprise user device 105 may, in some instances, be special-purpose computing devices configured to perform specific functions.

Referring to FIG. 1B, delta code identification and validation platform 102 may include one or more processors (e.g., processor 111), memory 112, and a communication interface (e.g., communication interface 113). A data bus may interconnect the processor 111, memory 112, and communication interface 113. Communication interface 113 may be a network interface configured to support communication between delta code identification and validation platform 102 and one or more networks (e.g., network 101, or the like). Communication interface 113 may be communicatively coupled to the processor(s) 111. The memory may include one or more program modules having instructions that when executed by processor(s) 111 cause delta code identification and validation platform 102 to perform one or more functions described herein and/or one or more databases that may store and/or otherwise maintain information which may be used by such program modules and/or processor(s) 111. In some instances, the one or more program modules and/or databases may be stored by and/or maintained in different memory units of delta code identification and validation platform 102 and/or by different computing devices that may form and/or otherwise make up delta code identification and validation platform 102. For example, the memory may have, host, store, and/or include intelligent module 112a, intelligent database 112b, AI engine 112c, Q learning module 112d, and/or association mapping module 112c.

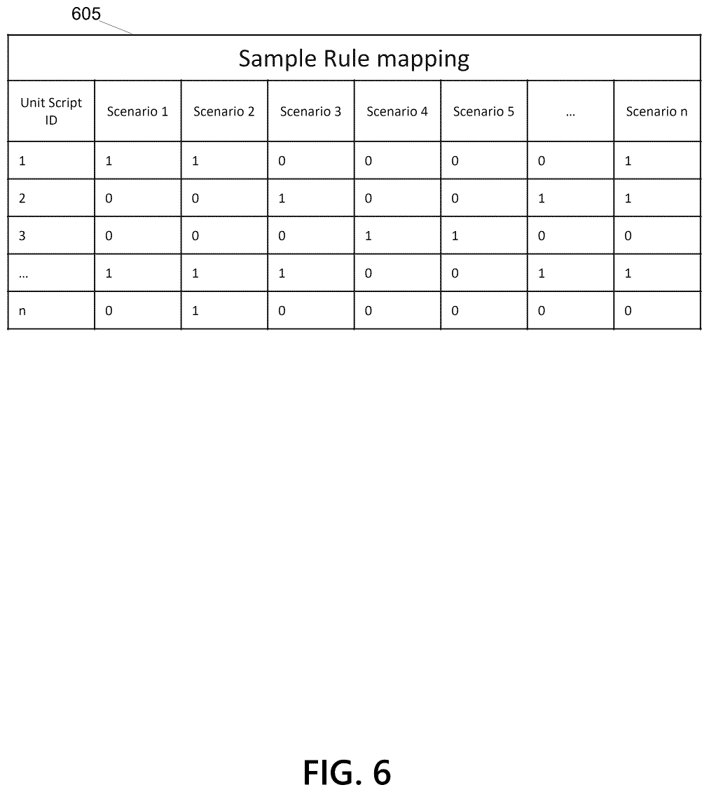

Intelligent module 112a may have instructions that direct and/or cause delta code identification and validation platform 102 to identify one or more scenarios based on delta code received from enterprise user device 105, identify one or more unit test cases to validate the delta code based on the identified scenarios, and/or perform other functions, as discussed in greater detail below. Intelligent database 112b may have instructions and/or data used by intelligent module 112a, and/or delta code identification and validation platform 102 to store information used by intelligent module 112a and/or delta code identification and validation platform 102, and/or performing other functions. AI engine 112c may implement, refine, train, maintain, and/or otherwise host, for example, a natural language processing (NLP) model, large language model (LLM), and/or similar models, that may be used to generate machine readable output for Q learning module 112d, and/or perform other methods described herein. Q learning module 112d may implement, refine, train, maintain, and/or otherwise host, for example, a model-free reinforcement learning algorithm, that may be used to identify one or more scenarios based on delta code received from enterprise user device 105, and/or perform other methods described herein. Association mapping module 112e may identify one or more unit test cases to validate the delta code based on the identified scenarios using an association mapping table (e.g., similar to what is shown in FIG. 6), and/or perform other methods described herein.

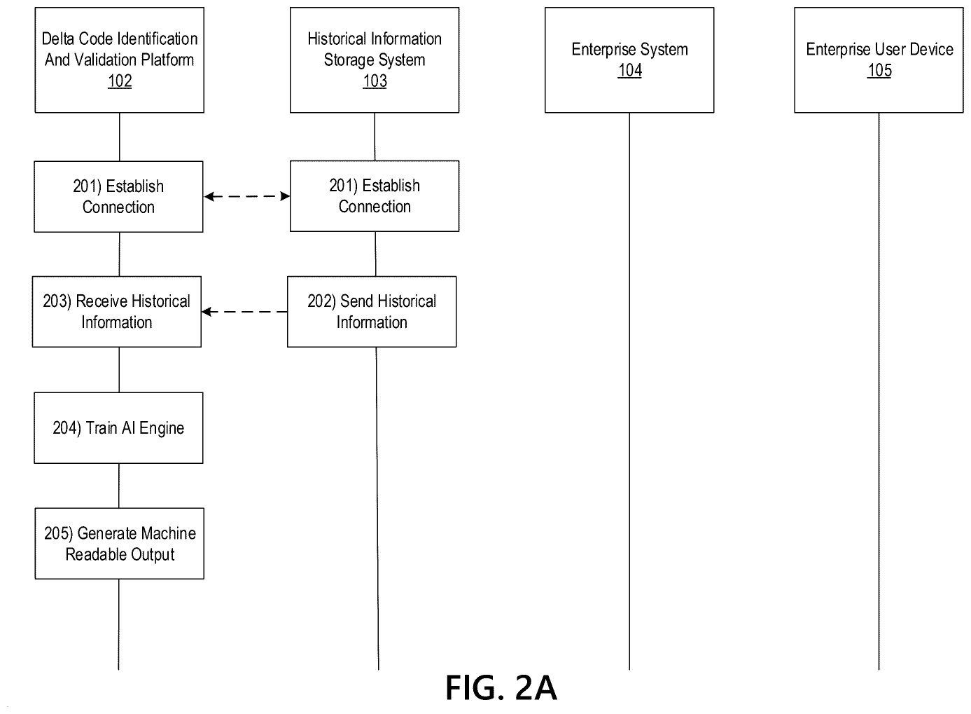

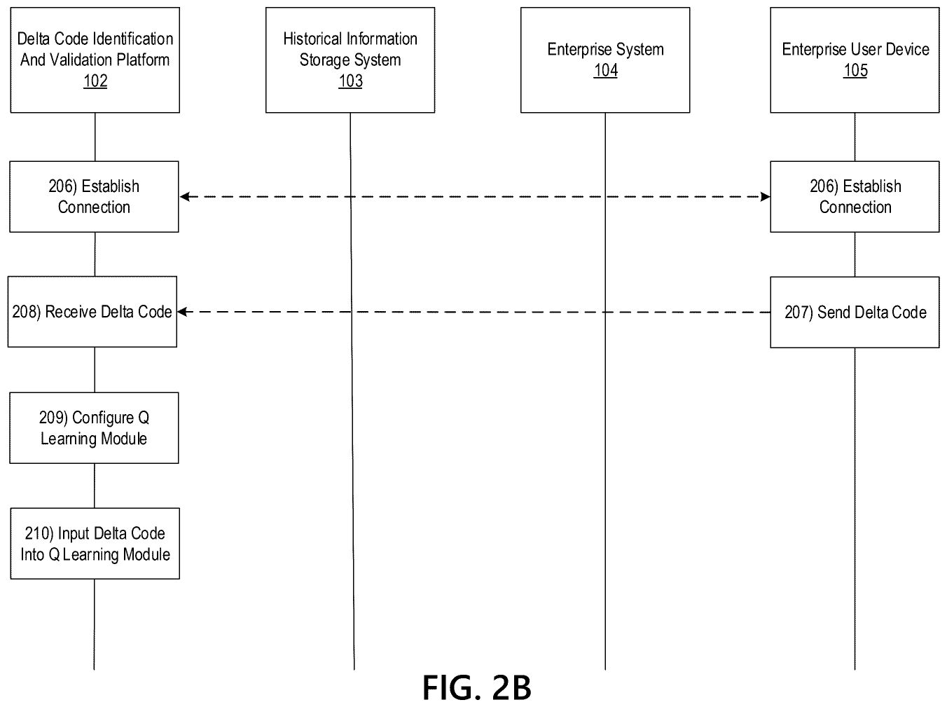

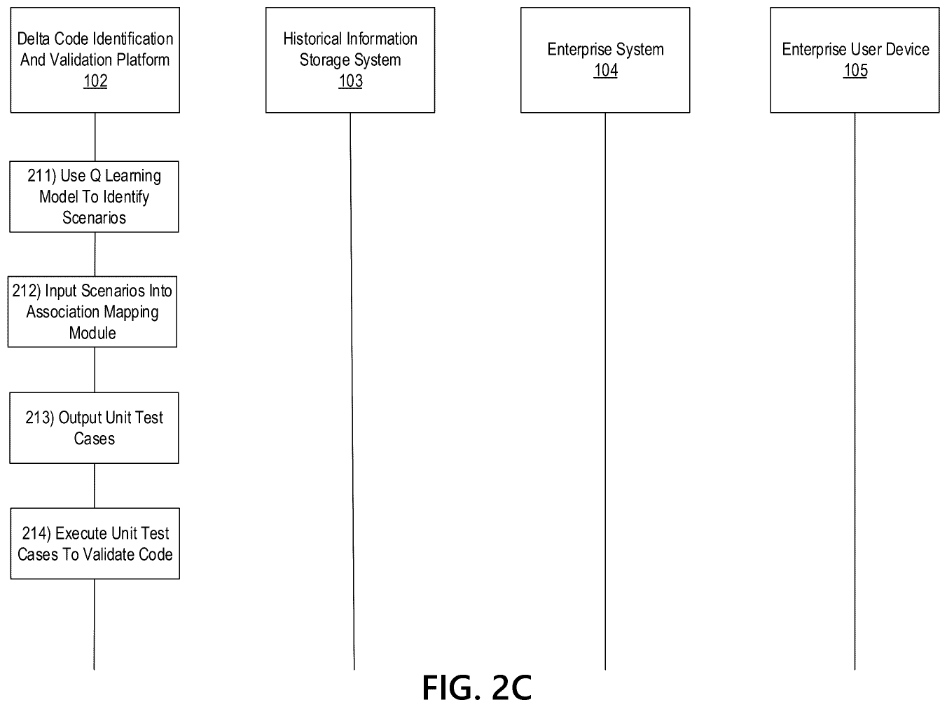

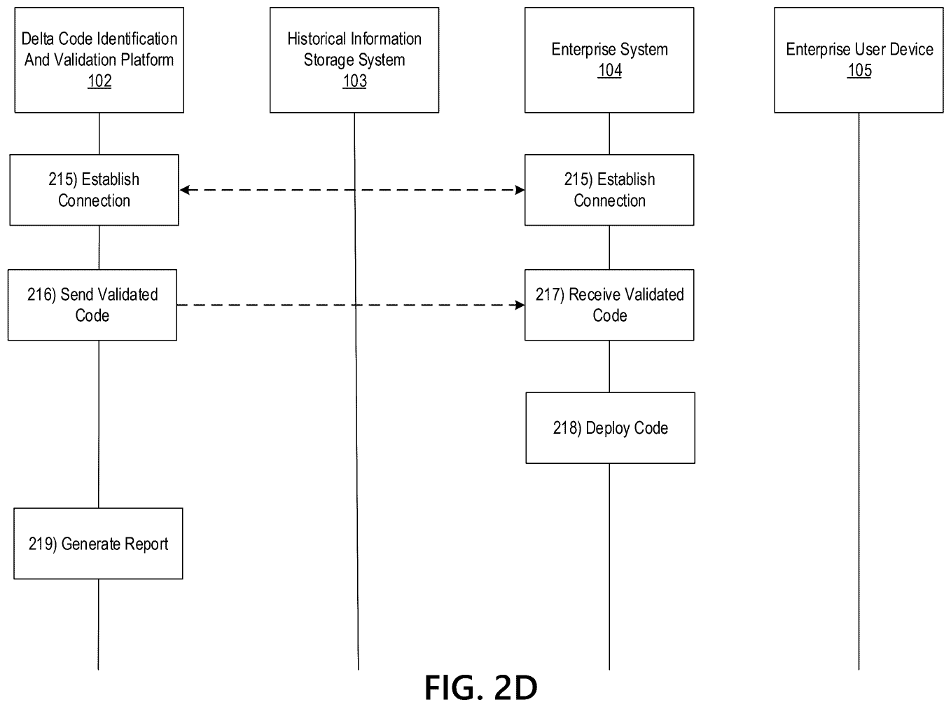

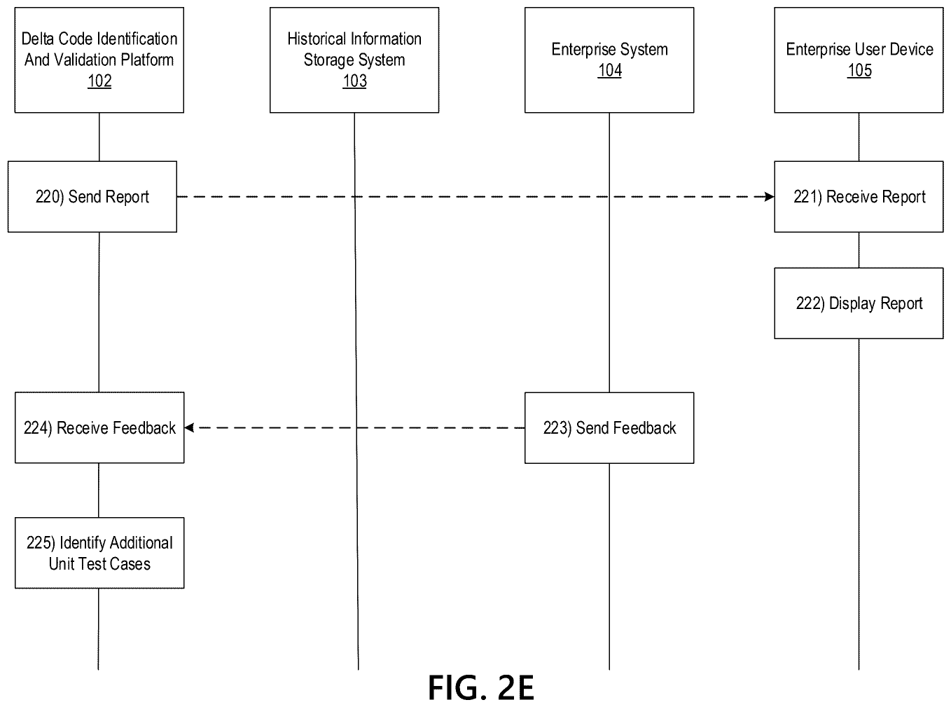

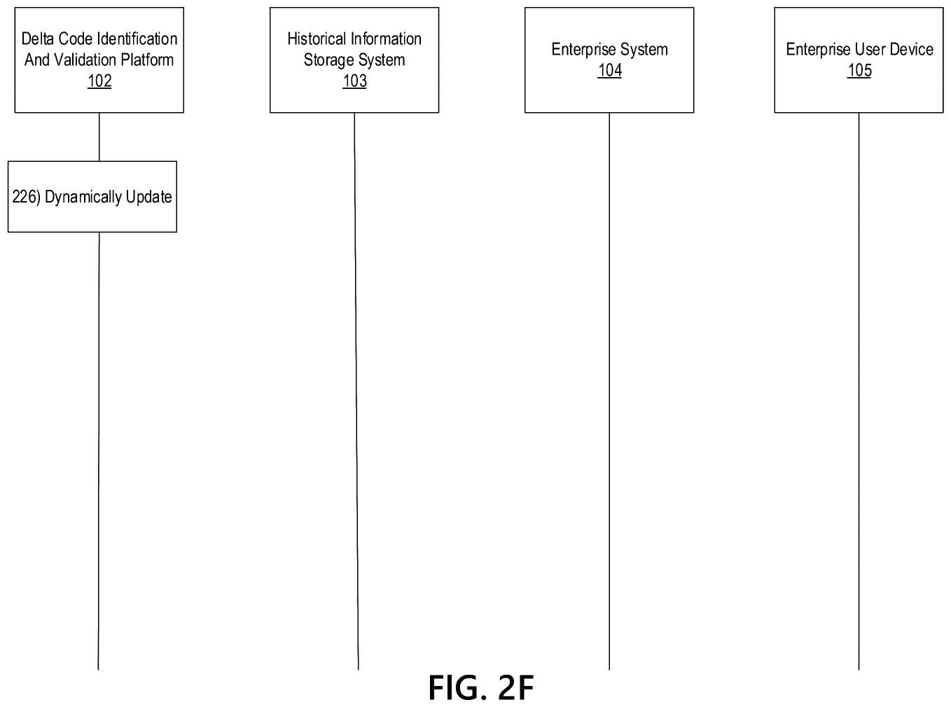

FIGS. 2A-2F depict an illustrative event sequence for delta code identification and validation in accordance with one or more aspects described herein. Referring to FIG. 2A, at step 201, historical information storage system 103 may establish a connection with delta code identification and validation platform 102. For example, historical information storage system 103 may establish a first wireless data connection with delta code identification and validation platform 102 to link historical information storage system 103 to delta code identification and validation platform 102 (e.g., in preparation for sending historical information). In some instances, historical information storage system 103 may identify whether or not a connection is already established with delta code identification and validation platform 102. If a connection is already established with delta code identification and validation platform 102, historical information storage system 103 might not re-establish the connection. If a connection is not already established with delta code identification and validation platform 102, historical information storage system 103 may establish the first wireless data connection as described herein.

At step 202, historical information storage system 103 may send historical information to delta code identification and validation platform 102. For example, historical information storage system 103 may send the historical information using the first wireless data connection and via communication interface 113.

At step 203, delta code identification and validation platform 102 may receive the historical information. For example, delta code identification and validation platform 102 may receive the historical information using the first wireless data wireless and via communication interface 113. For example, in receiving the historical information, the delta code identification and validation platform 102 may receive information about historical defects in previously deployed code (e.g., software bugs), peer review comments about previous code version releases and/or updates, post-production issues, and/or similar information, which may be used in furtherance of performing the functions described herein.

At step 204, delta code identification and validation platform 102 may train an AI engine (e.g., AI engine 112c) to generate machine readable outputs based on the historical information that was received in step 203. In some instances, the AI engine may utilize unsupervised learning, in which unlabeled data may be input into the AI engine. For example, unsupervised learning techniques such as k-means, gaussian mixture models, frequent pattern growth, and/or other unsupervised learning techniques may be used. Additionally or alternatively, the AI engine may utilize a supervised learning model/engine, which may utilize labeled inputs and outputs to perform the training. Using labeled inputs and outputs, the AI engine may measure its accuracy and learn over time. For example, supervised learning techniques such as linear regression, classification, neural networking, and/or other supervised learning techniques may be used. Additionally or alternatively In some instances, the AI engine may be a combination of supervised and unsupervised learning.

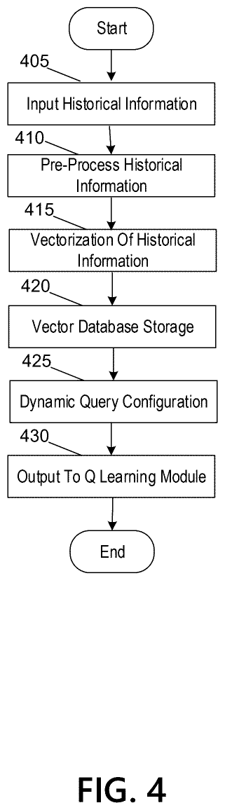

For example, the training may be similar to what is shown in FIG. 4. With reference to FIG. 4, at step 405, a computing platform (e.g., delta code identification and validation platform 102) having at least one processor, a communication interface, and memory may input historical information into the AI engine.

At step 410, the computing platform may preprocess the historical information. Preprocessing the information may include cleansing, validating, and/or curing the information. In some instances, this may include performing initial data quality checks (which may include, e.g., ensuring the data is current, accurate, and complete). In this manner, the computing platform may turn unstructured data (e.g., the historical information) into structured data that may be vectorized, as discussed in step 415.

At step 415, the computing platform may vectorize the historical information. Vectorizing the information may include converting the information from a raw format into a vector format that may subsequently be stored in step 420. At step 420, the computing platform may input the vectorized information into a vector database for storage. In some instances, the database may be intelligent database 112b. In some instances, the database may be associated with memory within AI engine 112c.

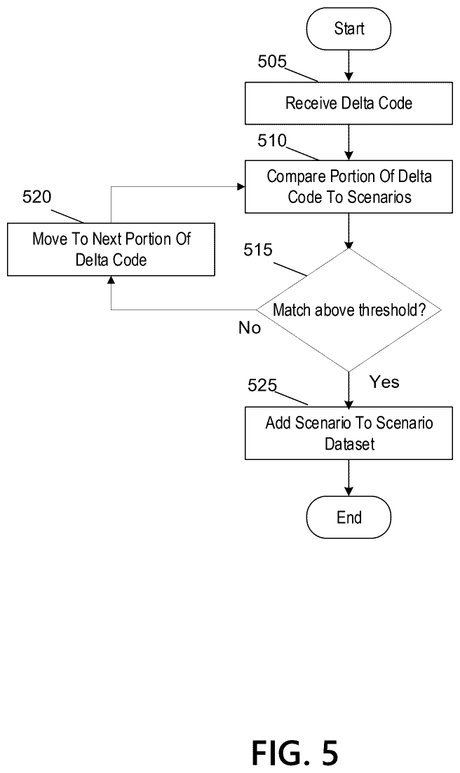

At step 425, the computing platform may configure a dynamic query module. In this manner, when Q learning module 112d is performing its functions (e.g., what is shown and described with respect to FIG. 5, the computing platform may dynamically provide inputs to Q learning module 112d in furtherance of identifying one or more scenarios associated with the delta code. In some instances, the computing platform may utilize an application programming interface (API) without departing from the scope of the disclosure.

At step 430, the computing platform may output machine readable information associated with the historical information to Q learning module 112d. In some instances, the computing platform may perform step 430 dynamically in response to feedback from Q learning module 112d.

Returning to the illustrative event sequence and in reference to FIG. 2A, at step 205, delta code identification and validation platform 102 may generate machine readable output based on the training that was performed in step 205 and/or input received from any of historical information storage system 103, enterprise system 104, and/or enterprise user device 105. In some instances, the generating performed in step 205 may be outputted to Q learning module 112d, which may serve as an input to the configuring performed in step 209.

Referring to FIG. 2B, at step 206, enterprise user device 105 may establish a connection with delta code identification and validation platform 102. For example, enterprise user device 105 may establish a second wireless data connection with delta code identification and validation platform 102 to link enterprise user device 105 to delta code identification and validation platform 102 (e.g., in preparation for sending delta code). In some instances, enterprise user device 105 may identify whether or not a connection is already established with delta code identification and validation platform 102. If a connection is already established with delta code identification and validation platform 102, enterprise user device 105 might not re-establish the connection. If a connection is not already established with delta code identification and validation platform 102, enterprise user device 105 may establish the second wireless data connection as described herein.

At step 207, enterprise user device 105 may send delta code to delta code identification and validation platform 102. For example, 105 may send the delta code to delta code identification and validation platform 102 using the second wireless data connection and via communication interface 113. For example, in sending the delta code the enterprise user device 105 may send new software code that may include one or more code changes when compared to an existing software code. In some instances, the delta code may be used (after being validated) as part of an application or system update at enterprise system 104. In some instances, delta code identification and validation platform 102 may monitor enterprise user device 105 for delta code (e.g., at a predetermined interval, non-uniform interval, and/or otherwise) without departing from the scope of the disclosure.

At step 208, delta code identification and validation platform 102 may receive the delta code. For example, delta code identification and validation platform 102 may receive the delta code using the second wireless data wireless and via communication interface 113.

At step 209, delta code identification and validation platform 102 may configure a Q learning module (e.g., Q learning module 112d) based on the machine readable output from step 206 and/or a database of scenarios (stored at, e.g., intelligent database 112b) related to previous code changes/updates that were previously deployed on enterprise system 104. For example, a scenario may refer to a situation in which a particular portion of code change affects how the updated application may function, which may need to be validated in order for the updated application to function properly. For example, a scenario may be a boundary value check, a null value check, a change data capture type check, and/or similar checks/scenarios. In this manner, Q learning module 112d may be configured to, based on receiving delta code from enterprise user device 105, output one or more scenarios related to changes between an existing code and the delta code, as discussed in more detail with respect to FIG. 5.

At step 210, delta code identification and validation platform 102 may input the delta code into the configured Q learning module 112d. For example, the inputting may be performed, manually, automatically, and/or based on a period of time without departing from the scope of the disclosure.

Referring to FIG. 2C, at step 211, delta code identification and validation platform 102 may use the Q learning module 112d to identify one or more scenarios related to the code changes of the delta code (i.e., differences between the existing code and the new delta code).

For example, using the Q learning module 112d may be similar to what is shown in FIG. 5. With reference to FIG. 5, at step 505, a computing platform (e.g., delta code identification and validation platform 102) having at least one processor, a communication interface, and memory may receive delta code. For example, the received delta code may be in a vector format where each element of the vector contains a portion of the delta code that may be different compared to the existing code.

At step 510, the computing platform may compare one or more portions of the delta code to one or more scenarios to identify a match between the portion of the delta code and any given scenario. For example, the Q learning module 112d may perform step 510 based on the following equation:

$$Q ( s , a ) ← Q ( s , a ) + α [ r + γ {max}_{{a}^{′}} Q ( {s}^{′} , {a}^{′} ) - Q ( s , a ) ] \qquad ( 1 )$$

The equation described in Equation (1) may include a state ‘s’ (i.e., the delta code/portion of the delta code), actions ‘a’ (i.e., the one or more scenarios), and rewards ‘r’ (i.e., a relationship match between a scenario and the portion of the delta code. Alpha ‘a’ may refer to a learning rate associated with Equation (1), and gamma ‘γ’ may refer to a discount factor associated with Equation (1).

At step 515, the computing platform may determine whether there is a match between the portion of the delta code and any of the scenarios that is greater than a threshold. For example, the threshold may refer to a numerical indication (i.e., 0.7), above which a match is determined to occur. This may represent, for example, similarity between the portion of the delta code and the identified scenario such that there is a confidence that the identified scenario accurately reflects the change in the code (e.g., a change in the code related to a boundary value or a null point, which may correspond to, respectively, a boundary value scenario or a null point scenario). In some instances, a scenario may refer to a common pattern in a previous code update that may be similar to the current portion of the delta code. In some instances, a scenario may refer to a missed scenario that was not previously identified and caused an issue in a previous code update.

If there is a match above the threshold, the computing platform may proceed to step 525. If there is not a match above the threshold, the computing platform may proceed back to step 510. At step 520, the computing platform may add the identified scenario to a dataset, which may be subsequently used to identify one or more unit test cases to validate the delta code, as discussed in more detail with respect to FIG. 6.

Returning to the illustrative event sequence and in reference to FIG. 2C, at step 212, delta code identification and validation platform 102 may input the scenarios that were identified as part of the discussion surrounding FIG. 4, into an associated mapping module (e.g., association mapping module 112c).

In some instances, the association mapping module 112e may include a table similar to what is shown in FIG. 6 (e.g., diagram 605). For example, diagram 605 may show a mapping between each scenario and one or more unit test cases based on the scenario (a mapping, e.g., stored in a matrix within memory associated with association mapping module 112e). For example, for each identified scenario, there may be one or more unit test cases (i.e., test scripts), that may validate the portion of the delta code that corresponds to the identified scenario related to that portion of the delta code.

At step 213, delta code identification and validation platform 102 may output unit test cases using the association mapping module 112e. In some instances, every unit test case associated with the identified scenarios may be outputted at step 213 and used to validate the delta code at step 214. In some instances, the most frequent unit test cases may be used (e.g., the 1000 most frequently identified unit test cases). In some instances, overlapping unit test cases across the identified scenarios may be used to validate the delta code. In this manner, delta code identification and validation platform 102 may solve technical problems related to finding a number of unit test cases to validate the delta code without leading to issues in post-production, while minimizing the total number of unit test cases used. For example, there may be 1,000,000 unit test cases that may be used to validate the delta code, however, executing all unit test cases to validate the delta code for an application may utilize a significant amount of time and excess computing resources when application updates occur frequently (e.g., updates every week). Utilizing what was described with reference to step 212 and step 213 (e.g., inputting the identified scenarios into the associated mapping module and outputting unit test cases to validate the delta code) might lead to running 10,000 unit test cases to validate the delta code (for the application update), while still accurately validated the delta code.

In some instances, delta code identification and validation platform 102 may store the unit test cases that were not identified/used to validate the delta code without departing from the scope of the disclosure.

At step 214, delta code identification and validation platform 102 may execute the unit test cases to validate the delta code. In this manner, delta code identification and validation platform 102 may validate the delta code using the unit test cases that were outputted by association mapping module 112e at step 213.

Referring to FIG. 2D, at step 215, delta code identification and validation platform 102 may establish a connection with enterprise system 104. For example, delta code identification and validation platform 102 may establish a third wireless data connection with enterprise system 104 to link delta code identification and validation platform 102 to enterprise system 104 (e.g., in preparation for the validated delta code). In some instances, delta code identification and validation platform 102 may identify whether or not a connection is already established with enterprise system 104. If a connection is already established with enterprise system 104, delta code identification and validation platform 102 might not re-establish the connection. If a connection is not already established with enterprise system 104, delta code identification and validation platform 102 may establish the third wireless data connection as described herein.

At step 216, delta code identification and validation platform 102 may send validated delta code to enterprise system 104 and commands directing enterprise system 104 to build and/or deploy the validated delta code at enterprise system 104. For example, delta code identification and validation platform 102 may send the validated delta code and the commands using the third wireless data connection and via communication interface 113.

At step 217, enterprise system 104 may receive the validated code and commands to build and/or deploy the validate coded. For example, enterprise system 104 may receive the validated delta code and the commands using the third wireless data wireless and via communication interface 113.

At step 218, enterprise system 104 may build and/or deploy the validated delta code based on what was received at step 217 (e.g., the validated code and commands to build and/or deploy the validated code).

At step 219, delta code identification and validation platform 102 may generate a report. In some instances, the report may be similar to what is shown in FIG. 7. With reference to FIG. 7, report 705 may show the identified scenarios, unit test cases that were used to validate the delta code, and/or other similar information.

Referring to FIG. 2E, at step 220, delta code identification and validation platform 102 may send the report to enterprise user device 105 and commands directing enterprise user device to display the report. For example, delta code identification and validation platform 102 may send the report and the commands using the second wireless data wireless and via communication interface 113.

At step 221, enterprise user device 105 may receive the report and the commands directing enterprise user device 105 to display the report. For example, enterprise user device 105 may receive the report and the commands using the second wireless data wireless and via communication interface 113.

At step 222, enterprise user device 105 may, in response to receiving the report and the commands, display the report (e.g., display what is shown in FIG. 7—the identified scenarios, the unit test cases, and/or other similar information).

At step 223, enterprise system 104 may send feedback to delta code identification and validation platform 102. For example, enterprise system 104 may send the feedback using the second wireless data connection and via communication interface 113. In some instances, the enterprise system 104 may send feedback indicating any issues related to the deployed delta code that enterprise system 104 identifies during, for example, post-production.

For example, if enterprise system 104 identifies an issue with the deployed delta code, enterprise system 104 may send that feedback to delta code identification and validation platform 102 in order to identify additional unit test cases to revalidate the delta code, as discussed in more detail at step 225.

At step 224, delta code identification and validation platform 102 may receive the feedback using the second wireless data connection and via communication interface 113. In some instances, delta code identification and validation platform 102 may monitor enterprise system 104 for issues/feedback without departing from the scope of the disclosure.

At step 225, delta code identification and validation platform 102 may identify additional unit test cases based on the feedback that was received at step 225, which may subsequently be used to revalidate the delta code. Subsequently, the revalidated delta code may be sent back to enterprise system 104 with commands/instructions to redeploy the revalidated delta code. In some instances, steps 214-218 may be similarly repeated in furtherance of revalidating and/or redeploying the revalidated delta code. For example, unit test cases that were identified but not outputted to validate the delta code may be identified as the additional unit test cases.

Referring to FIG. 2F, at step 226, delta code identification and validation platform 102 may dynamically update the AI engine 112c, the Q learning module 112d, and/or the association mapping module 112e, based on the actions performed in 209-217, and/or 223-225, and/or based on feedback from any of historical information storage system 103, enterprise system 104, and/or enterprise user device 105. In doing so, delta code identification and validation platform 102 may dynamically and continuously update (e.g., using a dynamic feedback loop) and/or otherwise refine the AI engine, 112c, the Q learning module 112d, and/or the association mapping module 112e so as to increase accuracy of the AI engine, 112c, the Q learning module 112d, and/or the association mapping module 112e over time.

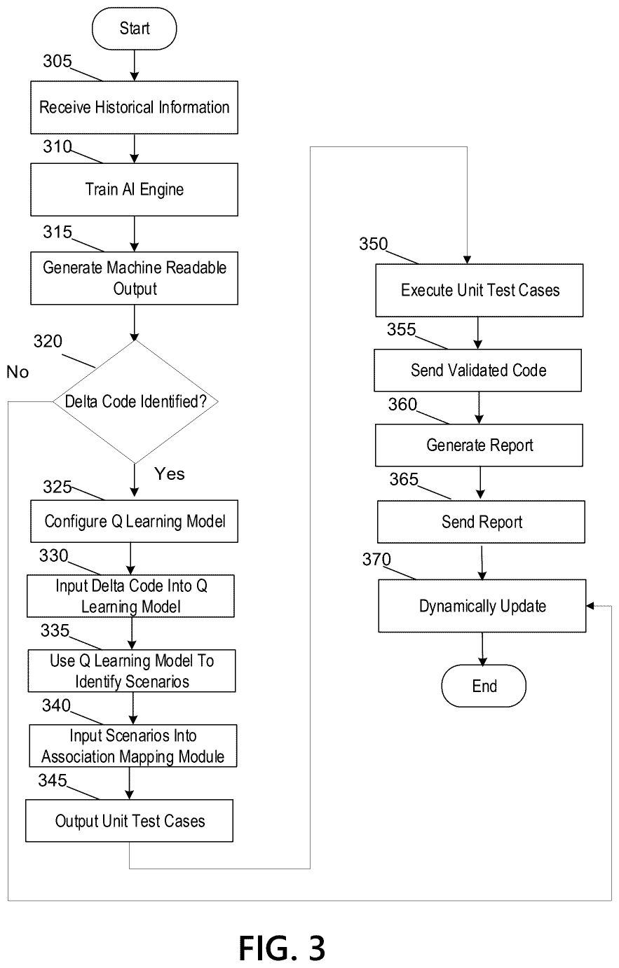

FIG. 3 depicts an illustrative method for implementing delta code identification and validation in accordance with one or more aspects described herein. At step 305, a computing platform having at least one processor, a communication interface, and memory may receive historical task information.

At step 310, the computing platform may train an AI engine. At step 315, the computing platform may generate machine readable output based on the training that was performed at step 310.

At step 320, the computing platform may determine whether delta code has been identified and/or received (by, e.g., enterprise user device 105). If delta code is identified, the computing platform may proceed to step 325. If delta code is not identified, the computing platform may proceed to step 370.

At step 325, the computing platform may configure a Q learning module (e.g., Q learning module 112d) based on machine readable output and a database of scenarios. At step 330, the computing platform may input the delta code into the configured Q learning module.

At step 335, the computing platform may use the Q learning module to identify one or more scenarios associated with the delta code. At step 340, the computing platform may input the scenarios into an association mapping module (e.g., association mapping module 112c).

At step 345, the computing platform may output unit test cases using the associated mapping module. At step 350, the computing platform may execute the unit test cases that were identified at step 345.

At step 355, the computing platform may send the validated code to an enterprise system 104 to build and/or deploy the validated code. At step 360, the computing platform may generate a report.

At step 365, the computing platform may send the report to enterprise user device 105. At step 370, the computing platform may dynamically update the AI engine, Q learning module, and/or the associated mapping module.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
use an artificial intelligence (AI) engine to convert historical information into machine readable information, wherein the historical information comprises one or more peer review comments and one or more historical defects;
configure a Q learning module using the machine readable information and a database of scenarios, wherein the configuring prepares the Q learning module to receive delta code and identify one or more scenarios from the database of scenarios associated with the delta code;
receive first delta code from an enterprise user device;
input the first delta code into the Q learning module;
output, using the Q learning module, based on the first delta code, and based on the machine readable information and the database of scenarios, one or more scenarios associated with the first delta code;
output, based on the one or more scenarios and using an association mapping module, one or more unit test cases, wherein the one or more unit test cases are used to validate the first delta code;
validate the first delta code using the one or more unit test cases; and
send, to an enterprise system, the validated first delta code and commands directing the enterprise system to deploy the validated first delta code, wherein the validated first delta code and the commands cause the enterprise system to deploy the validated first delta code.

2. The computing platform of claim 1, wherein the memory stores additional computer-readable instructions that, when executed by the at least one processor, cause the computing platform to:
generate a report, wherein the report comprises the one or more identified scenarios and the one or more unit test cases that were used to validate the first delta code.

3. The computing platform of claim 2, wherein the memory stores additional computer-readable instructions that, when executed by the at least one processor, cause the computing platform to:
send, to the enterprise user device, the report and one or more commands directing the enterprise user device to display the report, wherein sending the one or more commands directing the enterprise user device to display the report causes the enterprise user device to display the report.

4. The computing platform of claim 1, wherein the one or more unit test cases that are outputted by the association mapping module comprise overlapping unit test cases across the one or more identified scenarios.

5. The computing platform of claim 1, wherein the memory stores additional computer-readable instructions that, when executed by the at least one processor, cause the computing platform to:
receive one or more issues associated with the validated first delta code that was deployed at the enterprise system;
based on the one or more issues, identify one or more additional unit test cases to revalidate the validated first delta code using the association mapping module;
revalidate the validated first delta code using the one or more additional unit test cases; and
send, to the enterprise system, the revalidated first delta code and new commands directing the enterprise system to redeploy the revalidated first delta code, wherein the revalidated first delta code and the new commands cause the enterprise system to redeploy the revalidated first delta code.

6. The computing platform of claim 1, wherein the AI engine comprises a natural language processing (NLP) algorithm or a large language model (LLM).

7. The computing platform of claim 1, wherein the memory stores additional computer-readable instructions that, when executed by the at least one processor, cause the computing platform to:
train the AI engine, wherein the training comprises:
preprocessing the historical information;
vectorizing the historical information;
storing the vectorized information into a vector database;
performing a dynamic query of the vectorized information; and
outputting the vectorized information to the Q learning module.

8. The computing platform of claim 1, wherein the database of scenarios comprises:
one or more common patterns; or
one or more missed scenarios.

9. The computing platform of claim 5, wherein the memory stores additional computer-readable instructions that, when executed by the at least one processor, cause the computing platform to:
update, using a dynamic feedback loop and based on the receiving, the identifying, and the revalidating, the Q learning module.

10. The computing platform of claim 5, wherein the memory stores additional computer-readable instructions that, when executed by the at least one processor, cause the computing platform to:
send, to the enterprise user device, an updated report indicating that the validated first delta code was revalidated by the one or more additional unit test cases.

11. A method comprising:
at a computing platform comprising at least one processor, a communication interface, and memory:
using an artificial intelligence (AI) engine to convert historical information into machine readable information, wherein the historical information comprises one or more peer review comments and one or more historical defects;
configuring a Q learning module using the machine readable information and a database of scenarios, wherein the configuring prepares the Q learning module to receive delta code and identify one or more scenarios from the database of scenarios associated with the delta code;
receiving first delta code from an enterprise user device;
inputting the first delta code into the Q learning module;
outputting, using the Q learning module, based on the first delta code, and based on the machine readable information and the database of scenarios, one or more scenarios associated with the first delta code;
outputting, based on the one or more scenarios and using an association mapping module, one or more unit test cases, wherein the one or more unit test cases are used to validate the first delta code;
validating the first delta code using the one or more unit test cases; and
sending, to an enterprise system, the validated first delta code and commands directing the enterprise system to deploy the validated first delta code, wherein the validated first delta code and the commands cause the enterprise system to deploy the validated first delta code.

12. The method of claim 11, further comprising:
generating a report, wherein the report comprises the one or more identified scenarios and the one or more unit test cases that were used to validate the first code; and
sending, to the enterprise user device, the report and one or more commands directing the enterprise user device to display the report, wherein sending the one or more commands directing the enterprise user device to display the report causes the enterprise user device to display the report.

13. The method of claim 11, wherein the one or more unit test cases that are outputted by the association mapping module comprise overlapping unit test cases across the one or more identified scenarios.

14. The method of claim 11, further comprising:
receiving one or more issues associated with the validated first delta code that was deployed at the enterprise system;
based on the one or more issues, identifying one or more additional unit test cases to revalidate the validated first delta code using the association mapping module;
revalidating the validated first delta code using the one or more additional unit test cases; and
sending, to the enterprise system, the revalidated first delta code and new commands directing the enterprise system to redeploy the revalidated first delta code, wherein the revalidated first delta code and the new commands cause the enterprise system to redeploy the revalidated first delta code.

15. The method of claim 11, wherein the AI engine comprises a natural language processing (NLP) algorithm or a large language model (LLM).

16. The method of claim 11, further comprising:
training the AI engine, wherein the training comprises:
preprocessing the historical information;
vectorizing the historical information;
storing the vectorized information into a vector database;
performing a dynamic query of the vectorized information; and
outputting the vectorized information to the Q learning module.

17. The method of claim 11, wherein the database of scenarios comprises:
one or more common patterns; or
one or more missed scenarios.

18. The method of claim 14, further comprising:
updating, using a dynamic feedback loop and based on the receiving, the identifying, and the revalidating, the Q learning module.

19. The method of claim 14, further comprising:
sending, to the enterprise user device, an updated report indicating that the validated first delta code was revalidated by the one or more additional unit test cases.

20. One or more non-transitory computer-readable storing instructions that, when executed by a computing platform comprising at least one processor, a communication interface, and memory, cause the computing platform to:
use an artificial intelligence (AI) engine to convert historical information into machine readable information, wherein the historical information comprises one or more peer review comments and one or more historical defects;
configure a Q learning module using the machine readable information and a database of scenarios, wherein the configuring prepares the Q learning module to receive delta code and identify one or more scenarios from the database of scenarios associated with the delta code;
receive first delta code from an enterprise user device;
input the first delta code into the Q learning module;
output, using the Q learning module, based on the first delta code, and based on the machine readable information and the database of scenarios, one or more scenarios associated with the first delta code;
output, based on the one or more scenarios and using an association mapping module, one or more unit test cases, wherein the one or more unit test cases are used to validate the first delta code;
validate the first delta code using the one or more unit test cases; and
send, to an enterprise system, the validated first delta code and commands directing the enterprise system to deploy the validated first delta code, wherein the validated first delta code and the commands cause the enterprise system to deploy the validated first delta code.
